(19) United States
(12) Patent Application Publication
(10) Pub. No.: US 2006/0248109 A1
(43) Pub. Date: Nov. 2, 2006

(54) Filtering a view of information presented by an application based on attributes previously used by a user

(75) Inventor: Dean Anthony Racovolis, Redmond, WA (US)

Correspondence Address: WOLF GREENFIELD (Microsoft Corporation);C/O WOLF, GREENFIELD & SACKS, P.C., FEDERAL RESERVE PLAZA, 600 ATLANTIC AVENUE, BOSTON, MA, 02210-2206, US

(73) Assignee: Microsoft Corporation, Redmond, WA (US)

(21) Appl. No.: 11/118,650

(22) Filed: Apr. 29, 2005

(51) Int. Cl. G06F 7/00

(52) U.S. Cl. 707/102

(57) ABSTRACT

Systems and methods that simplify a user's ability to created filtered views of personal information items(e.g., calendar entries) presented by a personal organization application (e.g., a version of Microsoft® Outlook®). A user may be able to select a create filtered view tool from a tool bar provided by a user interface. In response to the selection, the user may be presented with a list of selectable attribute values for one or more attributes (e.g., labels and categories). For one or more attributes, the list of attribute values may include only those attribute values that have actually been used by the user for at least one personal information item (e.g., calendar entry). The user may select from the attribute value list, and the selected attribute value(s) may be used to filter the personal information items, from which a filtered view of the personal information items may be displayed.

### BACKGROUND

Several software applications available today such as, for example, Microsoft® Outlook® available from Microsoft Corporation and Lotus Notes available from IBM, enable users to create, edit, organize and/or manage personal information. Applications that enable users to create, edit, manage and/or organize personal information including, but not limited, email information, calendar information, task information, notes information and/or contact information are referred to herein as “personal organization applications”.

Typically, personal organization applications enable users to create, edit, organize and/or manage units of personal information referred to herein as “personal information items”, such as, for example, email messages, calendar entries, tasks, notes, contacts, other personal information or combinations thereof. Some personal organization applications, for example, Microsoft® Outlook®, provide attributes for information units, for which users can select values.

For example, Microsoft® Outlook® provides several attributes for calendar entries, including labels and categories. A user may select a value (e.g., color) for a label of a calendar entry from a list of available label values (e.g., colors). Each label value may represent a respective type of calendar entry of a plurality of types. Similarly, a user may select a value for a category of a calendar entry from a list of available category values.

As used herein, the term “personal information” does not connote information for which the content is confidential or private to an individual in some way (although it could be). Rather, what is meant by “personal” is that the information is defined for the user (possibly shared by others), for example, within one or more personal information items. For example, a user's calendar entry for a business meeting is personal information of the user because it is defined for the user, even though the business meeting is not necessarily confidential of private.

Typically, as the number of personal information items for a given user increases, it becomes more difficult to display the personal information units in a clear and intuitive manner. For example, a user may have tens, hundreds or even thousands of calendar entries defined for a given time period (e.g., a day, week or month). To address this issue, some versions of Microsoft® Outlook® enable a user to define a filtered view of the calendar entries. For example, users may be enabled to define filtered views based on calendar entry attributes, including categories and labels. However, the functionality in Microsoft® Outlook® to create a filtered view is buried under several levels of menu structure, making creating a filtered view a complicated task for a user. For example, to create a filtered view in certain versions of Microsoft® Outlook®, a user must:
Select View Menu;
Hover over Arrange By;
Hover over Current View in expanded menu;
Select Customize Current View;
Select Filter;
Select More Choices;
Select Categories and define which categories to filter
Select Advanced for Label filter
Select Field;
Hover over Frequently Used Fields;
Select Menu from expanded menu;
Select each label for filter and Select Add to List;
Repeat above step for each label to filter.

Further, even though a user may actually use only a limited number of the available labels and/or categories, the user is presented with lists of all the available labels and all of the available categories. These lists may be extensive and further complicate the user's ability to create a filtered view.

Thus, a need exists for a more simplified way for a user of a personal organization application to create filtered views of personal information items such as, for example, calendar entries.

### SUMMARY

Described herein are systems and methods that simplify a user's ability to created filtered views of personal information (e.g., calendar entries) presented by a personal organization application (e.g., a version of Microsoft® Outlook®).

In some embodiments, a user may be presented with a tool or other visual indicator, on a user interface, that enables a user to specify to create a filtered view of personal information items. In response to the user selecting the tool, the user may be presented with a list of selectable attribute values for one or more attributes (e.g., labels and categories). In some embodiments, for one or more attributes, the list of attribute values may include only those attribute values that have actually been used by the user for at least one personal information item (e.g., calendar entry). The user may select from the attribute value list, and the selected attribute value(s) may be used to filter the personal information items, from which a filtered view of the personal information items may be displayed. A definition of the filtered view may be stored and used to generate filtered views during later user sessions.

In an embodiment of the invention, a system is provided for enabling a user to filter personal information of the user provided by a personal organization application. The personal information includes a plurality of personal information items having at least one attribute, one or more of the personal information items having one or more values defined for the at least one attribute. The one or more values are selected from a plurality of values available for the at least one attribute. The system includes a query module to determine which values of the plurality of values have been selected for the at least one attribute for at least one of the plurality of personal information items. The system further includes a user interface to control a displaying of a list of the determined values to the user, and to control an enabling of the user to select one or more values, as one or more filter values, from the list of determined values. Further, the system includes a filtering module to filter the plurality of personal information items using the one or more filter values, resulting in a first set of personal information items including only personal information items for which the at least one attribute has at least one of the one or more filter values. The user interface is operative to display to the user only the first set of personal information items of the plurality of personal information items.

In an aspect of this embodiment, the system further includes one or more data sources in which to store a filtered view definition including information indicative of the one or more filter values.

In another aspect of this embodiment, the personal organization application is a version of Microsoft® Outlook®.

In another aspect of this embodiment, the information items are calendar entries.

In yet another aspect of this embodiment, one or more of the at least one attribute is a category.

In another aspect of this embodiment, one or more of the at least one attribute is a label.

In another aspect of this embodiment, the user interface is operative to control a display of a user-selectable tool enabling the user to specify to filter the personal information, and is operative to control the displaying of the determined values list to the user without requiring the user to provide any input between the selection of the user-selectable tool and the displaying of the determine values list.

In another aspect of this embodiment, the first set is a sub-set of the plurality of information items.

In another embodiment, a user is enabled to filter personal information of the user provided by a personal organization application. The personal information including a plurality of personal information items having at least one attribute, one or more of the personal information items having one or more values defined for the at least one attribute. The one or more values selected from a plurality of values available for the at least one attribute. It is determined which values of the plurality of values have been selected for the at least one attribute for at least one of the plurality of personal information items. A list of the determined values is displayed to the user. From the list of determined values, the user is enabled to select one or more values as one or more filter values. The plurality of personal information items are filtered using the one or more filter values, resulting in a first set of personal information items including only personal information items for which the at least one attribute has at least one of the one or more filter values. Only the first set of personal information items of the plurality of personal information items are displayed to the user.

In an aspect of this embodiment, the filtered view definition, including information indicative of the one or more filter values, is stored.

In another aspect of this embodiment, the personal organization application is a version of Microsoft® Outlook®.

In another aspect of this embodiment, the personal information items are calendar entries.

In yet another aspect of this embodiment, one or more of the at least one attribute is a category.

In another aspect of this embodiment, one or more of the at least one attribute is a label.

In another aspect of this embodiment, a user-selectable tool enabling the user to specify to filter the personal information is displayed. Displaying the determined values list is performed after displaying the user-selectable tool without requiring the user to provide any input between the displaying of the user-selectable tool and the displaying of the determined values list.

In another aspect of this embodiment, filtering the plurality of personal information items includes generating a sub-set of the plurality of information items as the first set.

In another embodiment of the invention, a computer program product is provided. The product includes a computer-readable medium, and computer-readable signals stored on the computer-readable medium defining instructions that, as a result of being executed by a computer, instruct the computer to perform the method of the embodiment of the invention described in the preceding paragraphs and/or one or more aspects thereof described in the preceding paragraphs.

Other advantages, novel features, and objects of the invention, and aspects and embodiments thereof, will become apparent from the following detailed description of the invention, including aspects and embodiments thereof, when considered in conjunction with the accompanying drawings, which are schematic and which are not intended to be drawn to scale. In the figures, each identical or nearly identical component that is illustrated in various figures is represented by a single numeral. For purposes of clarity, not every component is labeled in every figure, nor is every component of each embodiment or aspect of the invention shown where illustration is not necessary to allow those of ordinary skill in the art to understand the invention.

### BRIEF DESCRIPTION OF THE DRAWINGS

FIG. 1 is a screen shot illustrating an example of the user interface display enabling a user to create a filtered view of calendar information, according to some embodiments of the invention;

FIG. 2 is a block diagram illustrating an example of a system for creating and using a filtered view of personal information provided by a personal organization application, according to some embodiments of the invention;

FIGS. 3 and 4 are screenshots illustrating an example of a user interface display enabling a user to select, for filtering, one or more used values of a label attribute and one or more used values of a category attribute, in accordance with some embodiments of the invention;

FIG. 5 is a screen shot illustrating an example of a user interface display including a filtered view of personal organization information, according to some embodiments of the invention;

FIG. 6 is a flow chart illustrating an example of a method of creating a filtered view of personal information items based on attribute values that have actually been used by a user, according to some embodiments of the invention;

FIG. 7 is a block diagram illustrating an example of a computer system on which some embodiments of the invention may be implemented; and

FIG. 8 is a block diagram illustrating an example of a storage system that may be used as part of the computer system to implement some embodiments of the invention.

### DETAILED DESCRIPTION

Although several embodiments of the invention are described below primarily in relation to versions of Microsoft® Outlook®, in particular the calendar functionality provided by Microsoft® Outlook®, it should be appreciated that the invention is not so limited. Other personal organization applications may be used and are intended to fall within the scope of the invention. Also, although several embodiments of the invention described below are described in relation to calendar entries, it should be appreciated that the invention is not so limited, as embodiments of the invention may be applied to other types of personal information units such as, for example, e-mail messages, tasks, notes, contact entries, other personal information units, and any suitable combination of the foregoing. Further, although several embodiments of the invention are described below primarily in relation to label and category attributes, the invention is not so limited. Embodiments of the invention may be applied to other types of attributes for personal information items.

The function and advantage of these and other embodiments of the present invention will be more fully understood from the examples described below. The following examples are intended to facilitate a better understanding and illustrate the benefits of the present invention, but do not exemplify the full scope of the invention.

As used herein, whether in the written description or the claims, the terms “comprising”, “including”, “carrying”, “having”, “containing”, “involving”, and the like are to be understood to be open-ended, i.e., to mean including but not limited to. Only the transitional phrases “consisting of” and “consisting essentially of”, respectively, shall be closed or semi-closed transitional phrases, as set forth, with respect to claims, in the United States Patent Office Manual of Patent Examining Procedures (Eighth Edition, Revision 2, May 2004), Section 2111.03.

### EXAMPLES

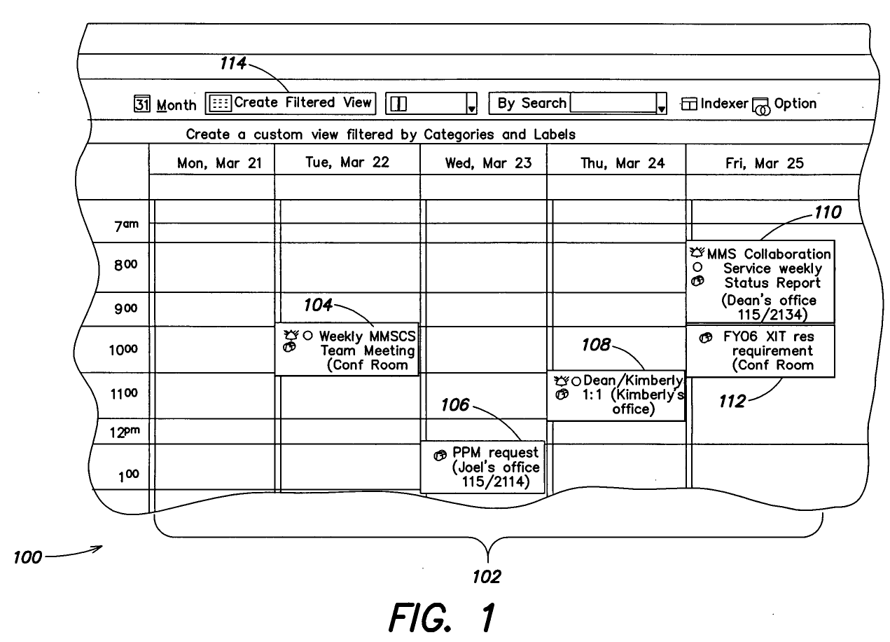

FIG. 1 is a screen shot illustrating an example of the user interface display 100 enabling a user to create a filtered view of calendar information, according to some embodiments of the invention. Display 100 is merely an illustrative embodiment of a display enabling a user to create a filtered view of calendar information, and is not intended to limit the scope of the invention. Any of numerous other implementations of such a display, for example, variations of display 100, are possible and are intended to fall within the scope of the invention.

As used herein, a “user interface” is an application or part of an application (i.e., a set of computer-readable instructions) that enables a user to interface with an application during execution of the application. A user interface may include code defining how an application outputs information to a user during execution of the application, for example, visually through a computer screen or other means, audibly through a speaker of other means, and manually through a game controller or other means. Such user interface also may include code defining how a user may input information during execution of the application, for example, audibly using a microphone or manually using a keyboard, mouse, game controller, track ball, touch screen or other means.

The user interface may define how information is visually presented (i.e., displayed) to the user, and defines how the user can navigate the visual presentation (i.e., display) of information and input information in the context of the visual presentation. During execution of the application, the user interface may control the visual presentation of information and enable the user to navigate the visual presentation and enter information in the context of the visual presentation. Types of user interfaces range from command-driven interfaces, where users type commands, menu-driven interfaces, where users select information from menus, and combinations thereof, to GUIs, which typically take more advantage of a computer's graphics capabilities, are more flexible, intuitive and easy to navigate and have a more appealing “look-and-feel” than command-driven and menu-driven visual user interfaces. As used herein, the visual presentation of information presented by a user interface or GUI is referred to as a “user interface display” or a “GUI display”, respectively.

Display 100 may include any of: calendar view 102; create filtered view tool 114; other elements; or any suitable combination of the foregoing. Calendar view 102 may be, in some embodiments, a view of a five-day or seven-day work week and may include one or more calendar entries such as, for example, calendar entries 104, 106, 108, 110 and 112.

Each calendar entry may have values defined for one or more attributes such as, for example, label and category. In some embodiments, label values are colors or shades of gray as illustrated by calendar entries 106, 110 and 112. Each color or shade of gray (or other kind of label) may be indicative of a type of the entry such as, for example, important, business, personal, vacation, must attend, travel required, needs preparation, birthday, anniversary, phone call, none, other types, or any suitable combination of the foregoing. Values of a category may include any of: business; competition; favorites; gifts, goals/objectives; holiday; holiday cards; hot contacts; ideas; international; key customer; miscellaneous; personal; phone calls; status; strategies; suppliers; time and expenses; VIP; waiting; other values; or any suitable combination of the foregoing.

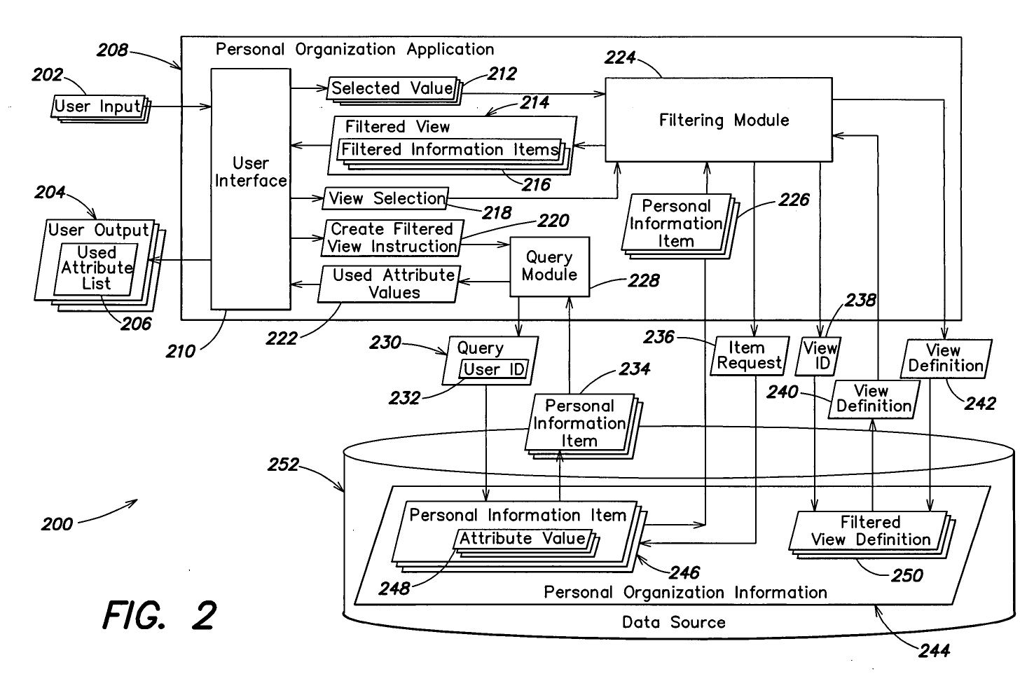

Create filter view control 114 may enable a user to specify to create a filtered view of the personal information (e.g., for the time period represented in display 100). It should be appreciated that display 100 may include additional calendar information not represented in FIG. 1 such as, for example, calendar entries corresponding to times after 1:00 during any particular day and/or that occur on Saturday or Sunday of the week represented in view 102. Display 100 may be provided by user interface 210 described below in relation to system 200 of FIG. 2.

FIG. 2 is a block diagram illustrating an example of a system 200 for creating and using a filtered view of personal information provided by a personal organization application (e.g., a version of Microsoft® Outlook®), according to some embodiments of the invention.

System 200 is merely an illustrative embodiment of a system for creating and using a filtered view of personal information provided by a personal organization application, and is not intended to limit the scope of the invention. Any of numerous other implementations of such a system, for example, variations of system 200, are possible and are intended to fall within the scope of the invention.

System 200 may include any of: personal organization application 208; one or more data sources 252; other components; or any suitable combination of the foregoing. Personal organization application 208 may be any of a plurality of personal organization applications such as, for example, a suitable version of Microsoft® Outlook®, Lotus Notes; or another personal organization application. Personal organization application 208 may include any of: user interface 210; filtering module 224; query module 228; other components; or any suitable combination of the foregoing.

User interface 210 may be configured to receive user input 202 and provide user output 204, which in some circumstances may include a used attribute list 206, as will be described in more detail below. User input 202 may include an instruction from a user to create a filtered view, for example, in response to a user selecting control 114 of display 100. In response, user interface 210 may communicate a create filtered view instruction 220 to a query module 228. Query module 228 may be configured to determine (e.g., in response to receiving instructions 220), for one or more attributes provided for personal information items, which attribute values for the attribute has actually been used by a given user (e.g., the user that initiated instruction 220).

Query module 228 may be configured to query personal information items 246 stored in data source 252, for example, by providing a query 230. Query 230 may include a user ID 232 of the user for whom the filtered view is being created (e.g., the user who initiated communication of instruction 220). Each personal information item 246 may include one or more attribute values 248 for each attribute of a personal information item. Query 230 may result in one or more personal information items 234 being sent from data source 252 to query module 228. Alternatively, data source 252 may include logic (e.g., in stored procedures) that returns not one or more personal information items 234, but rather an indication of the attribute values that have actually been used by the user for each attribute being queried. Query module 228 may be configured to determine the one or more attribute values used by a user for each queried attribute (if such information was not provided directly from the data source 252), and communicate the one or more used attribute values 222 to user interface 210.

User interface 210 may be configured to control a display of a list of the one or more used attribute values for a given attribute, for example, by providing used attribute list 206 as part of user output 204.

In some embodiments of the invention (e.g., if personal organization application is a suitable version of Microsoft® Outlook®, user interface 210 may be configured to provide user interface display 300.

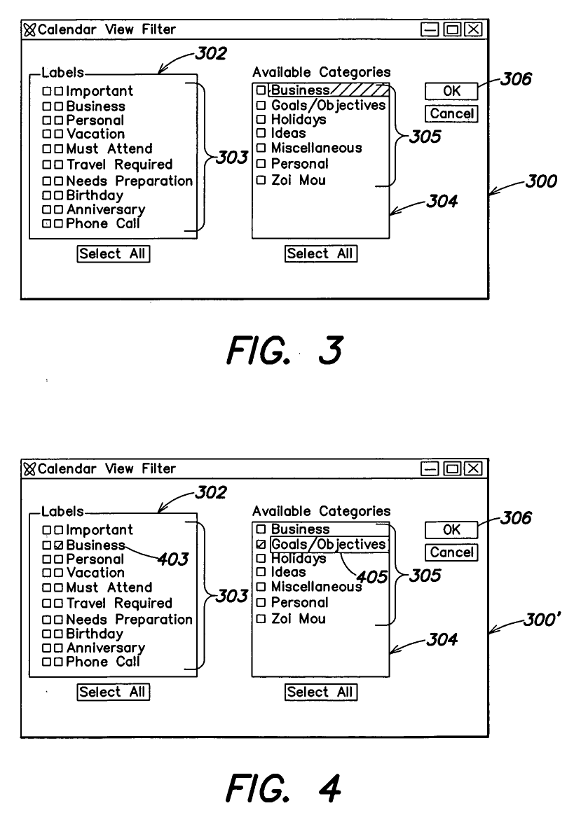

FIG. 3 is a screen shot illustrating an example of a user interface display 300 enabling a user to select one or more values of a label attribute and one or more values of a category attribute that have actually been used by a particular user, in accordance with some embodiments of the invention. Display 300 is merely an illustrative embodiment of a display enabling a user to select used attribute values for one or more attributes, and is not intended to limit the scope of the invention. Any of numerous other implementations of such a display, for example, variations of display 300, are possible and are intended to fall within the scope of the invention.

Display 300 may include any of: label value selection panel 302; category value selection panel 304; initiate control 306; other components (e.g., those shown but not labeled in FIG. 3); and any suitable combination of the foregoing.

Label value selection panel 302 may include a list 303 of selectable values that have been used by the user for at least one calendar entry (e.g., within a particular time period). A list of used label values is not limited to the list 303 shown in FIG. 3, but may include additional label values (if used by the user for a calendar entry) or less than all of the values shown in FIG. 3. In some embodiments, list 303 may include only one entry. Further, if the user has not used any labels for any calendar entries, a message to this effect may be displayed to the user in display 300 or in a different user interface display.

Category value panel 304 may include a list 305 of category values used by the user for at least one calendar entry (e.g., within a particular time period). List 305 may include additional values (if used by the user for at least one calendar entry) or less than the number of attribute values shown in list 305. In some embodiments, list 305 may include only one value. Further, if no categories have been used for any calendar entries, a message to this effect may be displayed to the user as part of display 300 or as part of another user interface display.

Each value entry in list 303 and/or 305 may be selectable by a user, for example, as illustrated in FIG. 4. FIG. 4 is a screen shot illustrating an example of a user interface display 300′ that may result from a user selecting value entry 403 from list 303 and value entry 405 from list 305. It should be appreciated that although only one attribute value is shown as being selected from list 303 and 305 the invention is not so limited, as two or more attribute values may be selected from each list.

After a user has selected one or more attribute values from one or more of lists 303 and 305, or after a user has decided not to select any attribute values, the user may select initialize control 306 (labeled “OK”) to initiate the creation of the filtered view.

Returning to FIG. 2, after a user has selected one or more attribute values and initiated creation of the filtered view, the one or more selected values 212 may be communicated from user interface 210 to filtering module 224. Filtering module 224 may be configured to access and receive one or more personal information items 226 defined for the user (e.g., within a particular time period) from personal organization information 244. Filtering module 224 may be configured to generate filtered view 214 by applying the one or more selected values 212 to the personal information items 226. For example, the filtering module 224 may be configured to select from the personal information items 226 only those personal information items that have all of the selected values defined for one or more attributes or at least one of the selected values defined for at least one attribute. That is, filtering module 224 may be configured to perform a logical OR operation using the selected attribute values or to perform a logical AND operation.

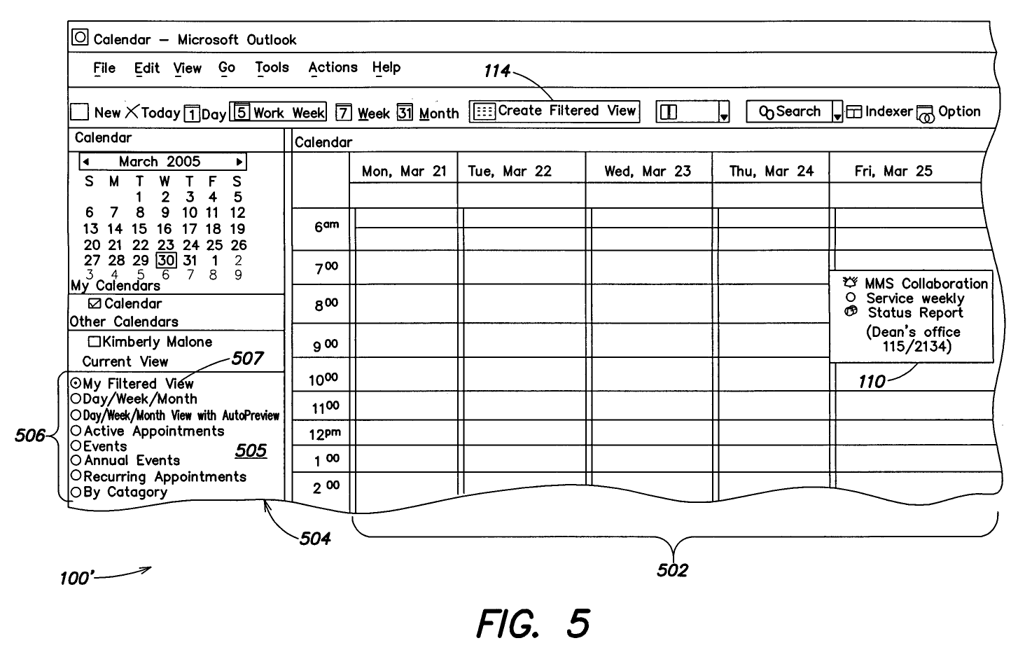

The resulting filtered view 214 may include the one or more filtered information items 216 resulting from the filtering operation performed by filtering module 224. The filter view 214 may be communicated to user interface 210 to be displayed, for example, as part of user interface display 100′ illustrated in FIG. 5.

Digressing briefly from FIG. 2, FIG. 5 is a screen shot illustrating an example of a user interface display 100′ including a filtered view 502 of personal organization information, according to some embodiments of the invention. Display 100′ is merely an illustrative embodiment of a display including a filtered view of personal information, and is not intended to limit the scope of the invention. Any of numerous other implementations of such a display, for example, variations of display 100′, are possible and are intended to fall within the scope of the invention.

Display 100′ may be provided by user interface 210, and may result from selected entries 403 and 405 being applied to calendar entries 104, 106, 108, 112 and other calendar entries defined for a particular user. As illustrated, of calendar entries 104, 106, 108, 110 and 112, filtered view 502 only includes calendar entry 110. In embodiments in which filter view 502 results from selected values 403 and 405, the inclusion of calendar entry 110 in filter view 502 may indicate that calendar entry 110 has a “Business” value defined (e.g., previously selected by the user) for the label attribute and/or a “Goals/Objectives” value defined for the category attribute, depending on how the filtering is configured.

Display 100′ also may include a calendar panel 504 including a current view pane 505. The current view panel 505 may include a list of available views, and may indicate which of the available views is currently being used to display personal organization information. In response to a user creating a filtered view, available view list 506 may include an entry 507 for the created view, for example, named “My Filtered View” in FIG. 5. Further, until a user selects another view, entry 507 may be indicated as being the current view, for example, by the radio button of the entry being filled as shown in FIG. 5.

Returning to FIG. 2, the definition 242 of the filtered view generated by filtering module 224 may be stored as one of the filtered view definitions 250 in personal organization information 244, and may be persisted between user sessions. Thus, the user may terminate the session in which the view definition 242 was created, and then use the view definition 242 at a later time to generate another filtered view. It should be appreciated that the personal information items and/or the time period involved may change between sessions such that different filtered views may be generated from a same view definition at different times.

For example, after a filtered view has been created and stored, user interface 210 may communicate a view selection 218 (e.g., within a user input 202) to filtering module 224. Filtering module 224 may be configured such that, in response to receiving view selection 218, it retrieves the appropriate view definition 240 from filtered view definitions 250, for example, by specifying a view id 238 of the view definition. Filtering module 224 also may be configured to retrieve the personal items 226 corresponding to the user who initiated the view selection 218, for example, by issuing an item request 236 (e.g., which may include the user's id) to data source 252. Filtering module 224 may be configured to generate a filtered view based on the retrieved personal information 226 and the retrieved view definition 240, and communicate this information to the user through user interface 210.

System 200 and components thereof, may be implemented using any of a variety of technologies, including software (e.g., C, C#, C++, Java, J# or a combination thereof), hardware (e.g., one or more application-specific integrated circuits), firmware (e.g., electrically-programmed memory) or any combination thereof. One or more of the components of system 200 may reside on a single device (e.g., a computer), or one or more components may reside on separate, discrete devices. Further, each component may be distributed across multiple devices, and one or more of the devices may be interconnected.

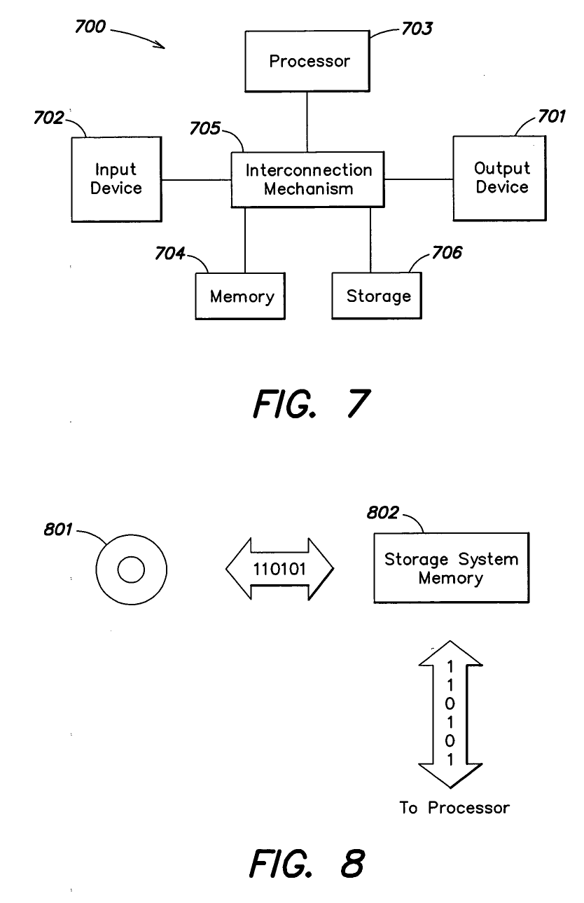

Further, on each of the one or more devices that include one or more components of system 200, each of the components may reside in one or more locations on the system. For example, different portions of the components of these systems may reside in different areas of memory (e.g., RAM, ROM, disk, etc.) on the device. Each of such one or more devices may include, among other components, a plurality of known components such as one or more processors, a memory system, a disk storage system, one or more network interfaces, and one or more busses or other internal communication links interconnecting the various components. System 200 and components thereof may be implemented using a computer system such as that described below in relation to FIGS. 7 and 8.

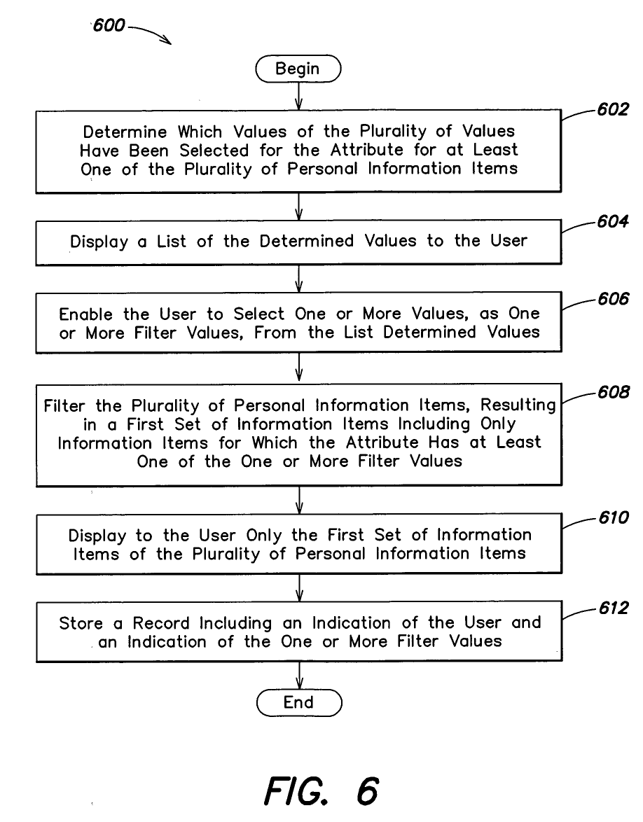

FIG. 6 is a flow chart illustrating an example of a method 600 of creating a filtered view of personal information items based on attribute values that have actually been used by a user for at least one personal information item, according to some embodiments of the invention. Method 600 is merely an illustrative embodiment of a method of creating a filtered view of personal information items based on attribute values that have actually been used, and is not intended to limit the scope of the invention. Any of numerous other implementations of such a method, for example, variations of method 600, are possible and are intended to fall within the scope of the invention.

In Act 602, the values, of the plurality of available values, that have been defined (e.g., previously selected) for a particular attribute (e.g., a label or category) for at least one of the plurality of personal information items (e.g., a calendar entries) may be determined, for example, as described above in relation to query module 228 of system 200. A list of these determined values that may be displayed to a user in Act 604, for example, as described above in relation to FIGS. 2 and 3.

In Act 606, from the list of attribute values determined in Act 602, the user may be enabled to select one or more values to be used as filter values, for example, as described above in relation to FIGS. 2 and 4.

In Act 608, the plurality of personal information items may be filtered using the filter values, resulting in a first set of information items including only information items for which the particular attribute has at least one of the one or more filter values. Act 608 may be performed in response to a user initiating creation of the filtered view as described above in relation to FIG. 4. The filtering operation performed as part of Act 608 may be performed by filtering module 224 of system 200 described above in relation to FIG. 2.

In Act 610, only the first set of information items of the plurality of personal information items may be displayed to a user, and a record (e.g., a view definition) including an indication of the user and an indication of the one or more filtered values may be stored, for example, as a filtered view definition 250 in data source 252.

As described above in relation to FIG. 2, the stored record (i.e., view definition) may be persisted between sessions and used to create a filtered view during a session other than the session in which the view definition was created.

Although method 600 is described in relation to filtering for only a single attribute, it should be appreciated that the invention is not so limited. Method 600 and acts thereof may be applied to a plurality of attributes of personal information items, and one or more attribute values may be selected (e.g., as described in relation to Act 606) and used to filter.

Method 600 may include additional acts. Further, the order of the acts performed as part of method 600 is not limited to the order illustrated in FIG. 6, as the acts may be performed in other order and/or one or more of the acts may be performed in parallel, at least partially. For example, act 612 may be performed prior to act 610 and/or in parallel.

Method 600, acts thereof and various embodiments and variations of these methods and acts, individually or in combination, may be defined by computer-readable signals tangibly embodied on or more computer-readable media, for example, non-volatile recording media, integrated circuit memory elements, or a combination thereof. Computer readable media can be any available media that can be accessed by a computer. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, other types of volatile and non-volatile memory, any other medium which can be used to store the desired information and which can accessed by a computer, and any suitable combination of the foregoing. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, wireless media such as acoustic, RF, infrared and other wireless media, other types of communication media, and any suitable combination of the foregoing.

Computer-readable signals embodied on one or more computer-readable media may define instructions, for example, as part of one or more programs, that, as a result of being executed by a computer, instruct the computer to perform one or more of the functions described herein (e.g., method 600 or any acts thereof), and/or various embodiments, variations and combinations thereof. Such instructions may be written in any of a plurality of programming languages, for example, Java, J#, Visual Basic, C, C#, or C++, Fortran, Pascal, Eiffel, Basic, COBOL, etc., or any of a variety of combinations thereof. The computer-readable media on which such instructions are embodied may reside on one or more of the components of any of systems 200, 700 and 800 described herein, may be distributed across one or more of such components, and may be in transition therebetween.

The computer-readable media may be transportable such that the instructions stored thereon can be loaded onto any computer system resource to implement the aspects of the present invention discussed herein. In addition, it should be appreciated that the instructions stored on the computer-readable medium, described above, are not limited to instructions embodied as part of an application program running on a host computer. Rather, the instructions may be embodied as any type of computer code (e.g., software or microcode) that can be employed to program a processor to implement the above-discussed aspects of the present invention.

It should be appreciated that any single component or collection of multiple components of a computer system, for example, the computer system described in relation to FIGS. 7 and 8, that perform the functions described herein can be generically considered as one or more controllers that control such functions. The one or more controllers can be implemented in numerous ways, such as with dedicated hardware and/or firmware, using a processor that is programmed using microcode or software to perform the functions recited above or any suitable combination of the foregoing.

Various embodiments according to the invention may be implemented on one or more computer systems. These computer systems may be, for example, general-purpose computers such as those based on Intel PENTIUM-type processor, Motorola PowerPC, Sun UltraSPARC, Hewlett-Packard PA-RISC processors, or any other type of processor. It should be appreciated that one or more of any type computer system may be used to convert text to speech and/or edit speech on a portable audio device according to various embodiments of the invention. Further, the software design system may be located on a single computer or may be distributed among a plurality of computers attached by a communications network.

A general-purpose computer system according to one embodiment of the invention is configured to perform convert text to speech and/or edit speech on a portable audio device. It should be appreciated that the system may perform other functions and the invention is not limited to having any particular function or set of functions.

For example, various aspects of the invention may be implemented as specialized software executing in a general-purpose computer system 700 such as that shown in FIG. 7. The computer system 700 may include a processor 703 connected to one or more memory devices 704, such as a disk drive, memory, or other device for storing data. Memory 704 is typically used for storing programs and data during operation of the computer system 700. Components of computer system 700 may be coupled by an interconnection mechanism 705, which may include one or more busses (e.g., between components that are integrated within a same machine) and/or a network (e.g., between components that reside on separate discrete machines). The interconnection mechanism 705 enables communications (e.g., data, instructions) to be exchanged between system components of system 700. Computer system 700 also includes one or more input devices 702, for example, a keyboard, mouse, trackball, microphone, touch screen, and one or more output devices 701, for example, a printing device, display screen, speaker. In addition, computer system 700 may contain one or more interfaces (not shown) that connect computer system 700 to a communication network (in addition or as an alternative to the interconnection mechanism 705.

The storage system 706, shown in greater detail in FIG. 8, typically includes a computer readable and writeable nonvolatile recording medium 801 in which signals are stored that define a program to be executed by the processor or information stored on or in the medium 801 to be processed by the program. The medium may, for example, be a disk or flash memory. Typically, in operation, the processor causes data to be read from the nonvolatile recording medium 801 into another memory 802 that allows for faster access to the information by the processor than does the medium 801. This memory 702 is typically a volatile, random access memory such as a dynamic random access memory (DRAM) or static memory (SRAM). It may be located in storage system 706, as shown, or in memory system 704, not shown. The processor 703 generally manipulates the data within the integrated circuit memory 704, 802 and then copies the data to the medium 801 after processing is completed. A variety of mechanisms are known for managing data movement between the medium 801 and the integrated circuit memory element 704, 802, and the invention is not limited thereto. The invention is not limited to a particular memory system 704 or storage system 706.

The computer system may include specially-programmed, special-purpose hardware, for example, an application-specific integrated circuit (ASIC). Aspects of the invention may be implemented in software, hardware or firmware, or any combination thereof. Further, such methods, acts, systems, system elements and components thereof may be implemented as part of the computer system described above or as an independent component.

Although computer system 700 is shown by way of example as one type of computer system upon which various aspects of the invention may be practiced, it should be appreciated that aspects of the invention are not limited to being implemented on the computer system as shown in FIG. 7. Various aspects of the invention may be practiced on one or more computers having a different architecture or components that that shown in FIG. 7.

Computer system 700 may be a general-purpose computer system that is programmable using a high-level computer programming language. Computer system 700 may be also implemented using specially programmed, special purpose hardware. In computer system 700, processor 703 is typically a commercially available processor such as the well-known Pentium class processor available from the Intel Corporation. Many other processors are available. Such a processor usually executes an operating system which may be, for example, the Windows® 95, Windows® 98, Windows NT®, Windows® 2000 (Windows® ME) or Windows® XP operating systems available from Microsoft Corporation, MAC OS System X available from Apple Computer, the Solaris Operating System available from Sun Microsystems, UNIX available from various sources or Linux available from various sources. Many other operating systems may be used.

The processor and operating system together define a computer platform for which application programs in high-level programming languages are written. It should be understood that the invention is not limited to a particular computer system platform, processor, operating system, or network. Also, it should be apparent to those skilled in the art that the present invention is not limited to a specific programming language or computer system. Further, it should be appreciated that other appropriate programming languages and other appropriate computer systems could also be used.

One or more portions of the computer system may be distributed across one or more computer systems (not shown) coupled to a communications network. These computer systems also may be general-purpose computer systems. For example, various aspects of the invention may be distributed among one or more computer systems configured to provide a service (e.g., servers) to one or more client computers, or to perform an overall task as part of a distributed system. For example, various aspects of the invention may be performed on a client-server system that includes components distributed among one or more server systems that perform various functions according to various embodiments of the invention. These components may be executable, intermediate (e.g., IL) or interpreted (e.g., Java) code which communicate over a communication network (e.g., the Internet) using a communication protocol (e.g., TCP/IP).

It should be appreciated that the invention is not limited to executing on any particular system or group of systems. Also, it should be appreciated that the invention is not limited to any particular distributed architecture, network, or communication protocol.

Various embodiments of the present invention may be programmed using an object-oriented programming language, such as SmallTalk, Java, C++, Ada, J# (J-Sharp) or C# (C-Sharp). Other object-oriented programming languages may also be used. Alternatively, functional, scripting, and/or logical programming languages may be used. Various aspects of the invention may be implemented in a non-programmed environment (e.g., documents created in HTML, XML or other format that, when viewed in a window of a browser program, render aspects of a graphical-user interface (GUI) or perform other functions). Various aspects of the invention may be implemented as programmed or non-programmed elements, or any combination thereof.

Having now described some illustrative embodiments of the invention, it should be apparent to those skilled in the art that the foregoing is merely illustrative and not limiting, having been presented by way of example only. Numerous modifications and other illustrative embodiments are within the scope of one of ordinary skill in the art and are contemplated as falling within the scope of the invention. In particular, although many of the examples presented herein involve specific combinations of method acts or system elements, it should be understood that those acts and those elements may be combined in other ways to accomplish the same objectives. Acts, elements and features discussed only in connection with one embodiment are not intended to be excluded from a similar role in other embodiments. Further, for the one or more means-plus-function limitations recited in the following claims, the means are not intended to be limited to the means disclosed herein for performing the recited function, but are intended to cover in scope any equivalent means, known now or-later developed, for performing the recited function.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

What is claimed is:

1. A system for enabling a user to filter personal information of the user provided by a personal organization application, the personal information including a plurality of personal information items having at least one attribute, one or more of the personal information items having one or more values defined for the at least one attribute, the one or more values selected from a plurality of values available for the at least one attribute, the system comprising:
a query module to determine which values of the plurality of values have been selected for the at least one attribute for at least one of the plurality of personal information items;
a user interface to control a displaying of a list of the determined values to the user, and to control an enabling of the user to select one or more values, as one or more filter values, from the list of determined values; and
a filtering module to filter the plurality of personal information items using the one or more filter values, resulting in a first set of personal information items including only personal information items for which the at least one attribute has at least one of the one or more filter values,
wherein the user interface is operative to display to the user only the first set of personal information items of the plurality of personal information items.

2. The system of claim 1, further comprising:
one or more data sources in which to store a filtered view definition including information indicative of the one or more filter values.

3. The system of claim 1, wherein the personal organization application is a version of Microsoft® Outlook®.

4. The system of claim 3, wherein the information items are calendar entries.

5. The system of claim 4, wherein one or more of the at least one attribute is a category.

6. The system of claim 4, wherein one or more of the at least one attribute is a label.

7. The system of claim 1, wherein the user interface is operative to control a display of a user-selectable tool enabling the user to specify to filter the personal information, and is operative to control the displaying of the determined values list to the user without requiring the user to provide any input between the selection of the user-selectable tool and the displaying of the determine values list.

8. The system of claim 1, wherein the first set is a sub-set of the plurality of information items.

9. A method of enabling a user to filter personal information of the user provided by a personal organization application, the personal information including a plurality of personal information items having at least one attribute, one or more of the personal information items having one or more values defined for the at least one attribute, the one or more values selected from a plurality of values available for the at least one attribute, the method comprising acts of:
(A) determining which values of the plurality of values have been selected for the at least one attribute for at least one of the plurality of personal information items;
(B) displaying a list of the determined values to the user;
(C) enabling the user to select one or more values, as one or more filter values, from the list of determined values;
(D) filtering the plurality of personal information items using the one or more filter values, resulting in a first set of personal information items including only personal information items for which the at least one attribute has at least one of the one or more filter values; and
(E) displaying to the user only the first set of personal information items of the plurality of personal information items.

10. The method of claim 9, further comprising an act of:
(F) storing the filtered view definition including information indicative of the one or more filter values.

11. The method of claim 9, wherein the personal organization application is a version of Microsoft® Outlook®.

12. The method of claim 11, wherein the personal information items are calendar entries.

13. The method of claim 12, wherein one or more of the at least one attribute is a category.

14. The method of claim 12, wherein one or more of the at least one attribute is a label.

15. The method of claim 9, further comprising an act of:
(F) displaying a user-selectable tool enabling the user to specify to filter the personal information,
wherein the act (B) is performed after the act (F) without requiring the user to provide any input between the performance of the act (F) and the performance of the act (B).

16. The method of claim 9, wherein the act (D) comprises generating a sub-set of the plurality of information items as the first set.

17. A computer program product comprising:
a computer-readable medium; and
computer-readable signals, stored on the computer-readable medium, that define instructions that, as a result of being executed by a computer, control the computer to perform a process of enabling a user to filter personal information of the user provided by a personal organization application, the personal information including a plurality of personal information items having at least one attribute, one or more of the personal information items having one or more values defined for the at least one attribute, the one or more values selected from a plurality of values available for the at least one attribute, the process comprising acts of:
(A) determining which values of the plurality of values have been selected for the at least one attribute for at least one of the plurality of personal information items;
(B) displaying a list of the determined values to the user;
(C) enabling the user to select one or more values, as one or more filter values, from the list of determined values;
(D) filtering the plurality of personal information items using the one or more filter values, resulting in a first set of personal information items including only personal information items for which the at least one attribute has at least one of the one or more filter values; and
(E) displaying to the user only the first set of personal information items of the plurality of personal information items.

18. The computer program product of claim 17, wherein the process further comprises an act of:
(F) storing the filtered view definition including information indicative of the one or more filter values.

19. The computer program product of claim 17, wherein the process further comprises an act of:
(F) displaying a user-selectable tool enabling the user to specify to filter the personal information,
wherein the act (B) is performed after the act (F) without requiring the user to provide any input between the performance of the act (F) and the performance of the act (B).

20. The method of claim 17, wherein the act (D) comprises generating a sub-set of the plurality of information items as the first set.
